(19) United States
(12) Patent Application Publication
(10) Pub. No.: US 2019/0345639 A1
(43) Pub. Date: Nov. 14, 2019

(54) POLY(PHENYLENE ETHER) FIBER, METHOD OF FORMING, AND ARTICLES THEREFROM

(71) Applicant: SABIC GLOBAL TECHNOLOGIES B.V., Bergen op Zoom (NL)

(72) Inventors: Robert John Hossan, Delmar, NY (US); Richard Peters, Hinsdale, MA (US)

(21) Appl. No.: 16/522,967

(22) Filed: Jul. 26, 2019

Related U.S. Application Data
(62) Division of application No. 14/132,672, filed on Dec. 18, 2013.

(51) Int. Cl. D01F 1/07; C08L 71/12; D01F 6/94; D01F 6/66; D01F 1/10

(52) U.S. Cl. CPC D01F 1/07; C08L 71/12; D01F 6/94; D01F 6/66; Y10T 428/298; Y10T 442/3171; Y10T 442/642; Y10T 428/249921; D01F 1/10

(57) ABSTRACT

Small diameter poly(phenylene ether) fibers can be consistently formed from a composition comprising specific amounts of a poly(phenylene ether), a processing aid, and optionally a poly(alkenyl aromatic). The processing aid can be LLDPE, a petroleum resin, or combinations thereof. The processing aid can optionally further comprise a phosphite or phosphonate. Flame retardants are minimized or excluded from the composition. The fibers can be melt spun without entanglement or breakage, and this improved processability enables small diameter fibers to be formed. The resulting fibers can be used in reinforcing structures for printed circuit boards.

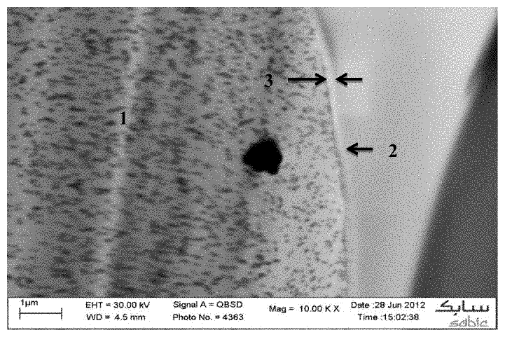

### CROSS-REFERENCE TO RELATED APPLICATIONS

This application is a divisional application of U.S. application Ser. No. 14/132,672, filed Dec. 18, 2013, which is incorporated by reference herein in its entirety.

### BACKGROUND OF THE INVENTION

Blends of poly(phenylene ether) and polystyrene can be melt spun into fibers. Since poly(phenylene ether) and polystyrene are miscible, they form a single amorphous phase. Thus properties of the poly(phenylene ether), such as melt viscosity, can affect the ease of spinning fibers from poly(phenylene ether)/polystyrene blends as well as from poly(phenylene ether) itself. As the level of poly(phenylene ether) in the blend increases, it becomes increasingly more difficult to spin fibers without excessive fiber breakage, especially at small fiber diameters. For poly(phenylene ether)/polystyrene fibers, the properties of the poly(phenylene ether), for example its dielectric properties, heat resistance, and hydrolytic resistance, are more valuable than the properties of the polystyrene. Therefore it is desirable to be able to melt spin fibers with a high poly(phenylene ether) content.

Blends of poly(2,6-dimethyl-1,4-phenylene ether) and polystyrene containing approximately 50 and 70 weight percent poly(2,6-dimethyl-1,4-phenylene ether) are commercially available. When attempting to melt spin these blends on a spinning line, it is very difficult to avoid fiber entanglement during startup and fiber breaks while running. As the amount of poly(2,6-dimethyl-1,4-phenylene ether) in poly(2,6-dimethyl-1,4-phenylene ether)/polystyrene blends increases, the more difficult it is to spin small diameter fibers. For example, the minimum fiber diameter obtainable with a 50 weight percent poly(2,6-dimethyl-1,4-phenylene ether) blend can be less than that of a 70 percent poly(2,6-dimethyl-1,4-phenylene ether) blend.

It is desirable to have poly(phenylene ether) compositions having high poly(phenylene ether) contents that can be consistently converted into small diameter fibers by melt spinning.

### BRIEF DESCRIPTION OF THE INVENTION

One embodiment is a fiber comprising a composition comprising 50 to 99.9 weight percent of a poly(phenylene ether); 0.1 to 10 weight percent of a processing aid comprising linear low density polyethylene, a petroleum resin, or combinations thereof; and 0 to 0.5 weight percent of a flame retardant; wherein all weight percents are based on the total weight of the composition.

Another embodiment is a fiber comprising a composition comprising: 79.8 to 99.8 weight percent of poly(2,6-dimethyl-1,4-phenylene ether); 0 to 20 weight percent of atactic polystyrene; 0.1 to 5 weight percent of linear low density polyethylene; 0.1 to 5 weight percent of triisodecyl phosphite; and 0 to 0.5 weight percent of a flame retardant comprising an organophosphate ester, a phosphine oxide, a phosphorus- and nitrogen-containing organic compound, a polymeric siloxane compound, a boron compound, or combinations thereof, based on the total weight of the composition; wherein all weight percents are based on the total weight of the composition.

Another embodiment is a method of spinning a fiber, comprising extruding through a spinneret a composition comprising: 50 to 99.9 weight percent of a poly(phenylene ether); 0.1 to 10 weight percent of a processing aid selected from linear low density polyethylene, a petroleum resin, and combinations thereof; and 0 to 0.5 weight percent of a flame retardant; wherein all weight percents are based on the total weight of the composition.

Another embodiment is an article comprising the fiber.

These and other embodiments are described in detail below.

### BRIEF DESCRIPTION OF THE DRAWING

The FIGURE is a scanning electron microscope image of a portion of the cross section of a fiber comprising the composition of Example 1. Feature 1 is the fiber core, feature 2 is the outer surface of the fiber, and a linear low density polyethylene (LLDPE) layer is present between the arrows of 3.

### DETAILED DESCRIPTION OF THE INVENTION

The present inventors have determined that small diameter poly(phenylene ether) fibers can be consistently melt spun from a composition comprising specific amounts of poly(phenylene ether), a processing aid, and optionally a poly(alkenyl aromatic). The fibers can be melt spun without entanglement or breakage, and this improved processability enables smaller diameter fibers to be formed compared to poly(phenylene ether) compositions lacking the processing aid. While not wishing to be bound by any particular theory of operation, the present inventors believe that the improved melt spinning is due to modification of the surface of the poly(phenylene ether) fibers. In particular, it is believed that a thin layer of the processing aid adheres to the surface of the fibers. The present inventors have also determined spinneret hole diameters that provide consistent and reliable melt spinning of poly(phenylene ether) compositions into small diameter fibers. These fibers can be formed into yarns, or woven or non-woven textiles. The fibers can also be formed into reinforcing textiles that can be used in fiber-reinforced composites, such as printed circuit boards.

In one embodiment, a fiber comprises a composition comprising: 50 to 99.9 weight percent of a poly(phenylene ether); 0 to 49.9 weight percent of a poly(alkenyl aromatic); 0.1 to 10 weight percent of a processing aid selected from linear low density polyethylene, a petroleum resin, and combinations thereof; and 0 to 0.5 weight percent of a flame retardant, wherein all weight percents are based on the total weight of the composition.

The fiber comprises a composition comprising a poly(phenylene ether). Examples of poly(phenylene ether)s include those comprising repeating structural units having the formula

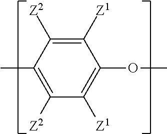

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it can, optionally, contain nitrogen, oxygen, sulfur in addition to carbon and hydrogen. Thus, when specifically described as substituted, the hydrocarbyl residue can also contain one or more carbonyl groups, amino groups, hydroxyl groups, or it can contain nitrogen, oxygen, or sulfur atoms within the backbone of the hydrocarbyl residue. For example, Z¹ can be a di-n-butylaminomethyl group formed by reaction of a 3,5-dimethyl-1,4-phenyl group with the di-n-butylamine component of an oxidative polymerization catalyst; or Z¹ can be a morpholinomethyl group formed by reaction of a 3,5-dimethyl-1,4-phenyl group with the morpholine component of an oxidative polymerization catalyst.

The poly(phenylene ether) can be a homopolymer, a copolymer, a graft copolymer, an ionomer, or a block copolymer, as well as combinations thereof.

The poly(phenylene ether) used to prepare the fiber can comprise 2,6-dimethyl-1,4-phenylene ether units, 2,3,6-trimethyl-1,4-phenylene ether units, or a combination thereof. In some embodiments, the poly(phenylene ether) comprises poly(2,6-dimethyl-1,4-phenylene ether).

The poly(phenylene ether) used to prepare the fiber can be essentially free of incorporated diphenoquinone residues. In the context, “essentially free” means that the fewer than 1 weight percent of poly(phenylene ether) molecules comprise the residue of a diphenoquinone. As described in U.S. Pat. No. 3,306,874 to Hay, synthesis of poly(phenylene ether) by oxidative polymerization of monohydric phenol yields not only the desired poly(phenylene ether) but also a diphenoquinone as side product. For example, when the monohydric phenol is 2,6-dimethylphenol, 3,3′,5,5′-tetramethyldiphenoquinone is generated. Typically, the diphenoquinone is “reequilibrated” into the poly(phenylene ether) (i.e., the diphenoquinone is incorporated into the poly(phenylene ether) chain) by heating the polymerization reaction mixture to yield a poly(phenylene ether) comprising terminal or internal diphenoquinone residues. For example, as shown in the Scheme, when a poly(phenylene ether) is prepared by oxidative polymerization of 2,6-dimethylphenol to yield poly(2,6-dimethyl-1,4-phenylene ether) and 3,3′,5,5′-tetramethyldiphenoquinone, reequilibration of the reaction mixture can produce a poly(phenylene ether) with terminal and internal residues of diphenoquinone.

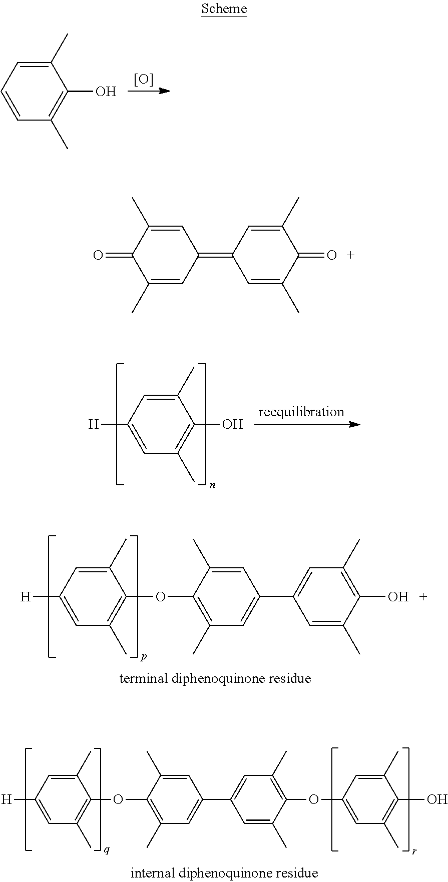

However, such reequilibration reduces the molecular weight of the poly(phenylene ether) (e.g., p and q+r are less than n). Accordingly, when a higher molecular weight poly(phenylene ether) is desired, it may be desirable to separate the diphenoquinone from the poly(phenylene ether) rather than reequilibrating the diphenoquinone into the poly(phenylene ether) chains. Such a separation can be achieved, for example, by precipitation of the poly(phenylene ether) in a solvent or solvent mixture in which the poly(phenylene ether) is insoluble and the diphenoquinone is soluble. For example, when a poly(phenylene ether) is prepared by oxidative polymerization of 2,6-dimethylphenol in toluene to yield a toluene solution comprising poly(2,6-dimethyl-1,4-phenylene ether) and 3,3′,5,5′-tetramethyldiphenoquinone, a poly(2,6-dimethyl-1,4-phenylene ether) essentially free of diphenoquinone can be obtained by mixing 1 volume of the toluene solution with about 1 to about 4 volumes of methanol or a methanol/water mixture. Alternatively, the amount of diphenoquinone side-product generated during oxidative polymerization can be minimized (e.g., by initiating oxidative polymerization in the presence of less than 10 weight percent of the monohydric phenol and adding at least 95 weight percent of the monohydric phenol over the course of at least 50 minutes), and/or the reequilibration of the diphenoquinone into the poly(phenylene ether) chain can be minimized (e.g., by isolating the poly(phenylene ether) no more than 200 minutes after termination of oxidative polymerization). These approaches are described in International Patent Application Publication No. WO2009/104107 A1 of Delsman et al. In an alternative approach utilizing the temperature-dependent solubility of diphenoquinone in toluene, a toluene solution containing diphenoquinone and poly(phenylene ether) can be adjusted to a temperature of about 25° C., at which diphenoquinone is poorly soluble but the poly(phenylene ether) is soluble, and the insoluble diphenoquinone can be removed by solid-liquid separation (e.g., filtration).

The poly(phenylene ether) used to prepare the fiber can comprise poly(phenylene ether) rearrangement products, such as bridging products and branching products. For example, poly(2,6-dimethyl-1,4-phenylene ether) can comprise the bridging group below:

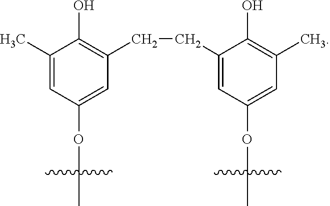 [SMILES: *Oc1cc(C)c(O)c(CCc2cc(O*)cc(C)c2O)c1]

This branching group is referred to herein as an “ethylene bridge group”. As another example, poly(2,6-dimethyl-1,4-phenylene ether) can comprise the branching group below:

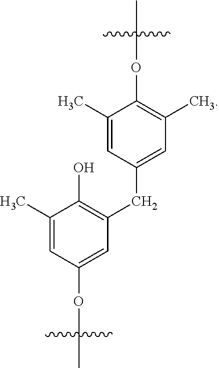 [SMILES: *Oc1cc(C)c(O)c(Cc2cc(C)c(O*)c(C)c2)c1]

This bridging group is referred to herein as a “rearranged backbone group”. These fragments can be identified and quantified by ³¹P nuclear magnetic resonance spectroscopy.

The inventors have determined that the lower the intrinsic viscosity and molecular weight of the poly(phenylene ether), the easier it is to spin fibers from the poly(phenylene ether) compositions. Without wishing to be bound by theory, the improved ease of spinning is believed to be related to the higher melt volume rate, which correlates with lower melt viscosity, of the poly(phenylene ether) compositions. Thus, the poly(phenylene ether) used to prepare the fiber can have an intrinsic viscosity of 0.25 to 1 deciliter per gram, as measured at 25° C. in chloroform. Within this range, the poly(phenylene ether) can have an intrinsic viscosity of 0.25 to 0.5 deciliters per gram, specifically 0.3 to 0.4 deciliters per gram. The poly(phenylene ether) can have a weight average molecular weight of 10,000 to 60,000 atomic mass units, as measured by gel permeation chromatography. Within this range, the poly(phenylene ether) can have a weight average molecular weight of 20,000 to 50,000 atomic mass units, specifically 25,000 to 35,000 atomic mass units. In some embodiments, the poly(phenylene ether) has an intrinsic viscosity of 0.25 to 0.5 deciliters per gram, as measured at 25° C. in chloroform.

The composition can comprise 50 to 99.9 weight percent, specifically 60 to 99 weight percent, a more specifically 70 to 98 weight percent, and still more specifically 85 to 95 weight percent, of the poly(phenylene ether), based on the total weight of the composition.

The composition optionally comprises a poly(alkenyl aromatic). The alkenyl aromatic monomer used to prepare the poly(alkenyl aromatic) can have the structure

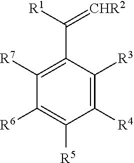

wherein R¹ and R² each independently represent a hydrogen atom, a C₁-C₈ alkyl group, or a C₂-C₈ alkenyl group; R³ and R⁷ each independently represent a hydrogen atom, a C₁-C₈ alkyl group, a chlorine atom, or a bromine atom; and R⁴, R⁵, and R⁶ each independently represent a hydrogen atom, a C₁-C₈ alkyl group, or a C₂-C₈ alkenyl group, or R⁴ and R⁵ are taken together with the central aromatic ring to form a naphthyl group, or R⁵ and R⁶ are taken together with the central aromatic ring to form a naphthyl group. Specific alkenyl aromatic monomers include, for example, styrene, chlorostyrenes such as p-chlorostyrene, and methylstyrenes such as alpha-methylstyrene and p-methylstyrene.

In some embodiments, the alkenyl aromatic monomer is styrene, and the poly(alkenyl aromatic) is polystyrene. Polystyrene refers to a homopolymer of styrene. Thus, the residue of any monomer other than styrene is excluded from the polystyrene. The polystyrene can be atactic, syndiotactic, or isotactic. In some embodiments, the polystyrene consists of atactic polystyrene. In some embodiments, the polystyrene has a melt volume flow rate of 1.5 to 5 cubic centimeters per 10 minutes, measured at 200° C. and a 5 kilogram load according to ISO 1133.

In some embodiments, poly(alkenyl aromatic) is excluded from the composition. As used herein, the term, “excluded” means that the excluded component is not added to, and is therefore absent from, the composition. Thus, in some embodiments, the composition comprises 90 to 99.9 weight percent of the poly(phenylene ether); 0.1 to 10 weight percent of the processing aid selected from linear low density polyethylene, a petroleum resin, and combinations thereof; and 0 to 0.5 weight percent of the flame retardant; wherein poly(alkenyl aromatic) is excluded from the composition, and wherein all weight percents are based on the total weight of the composition.

The composition can comprise 0 to 49.9 weight percent, specifically 1 to 49.9 weight percent, more specifically 1 to 40 weight percent, still more specifically 5 to 30 weight percent, and yet more specifically 5 to 15 weight percent, of poly(alkenyl aromatic), based on the total weight of the composition. In some embodiments, the composition comprises 50 to 99.9 weight percent of the poly(phenylene ether); 1 to 49.9 weight percent of the poly(alkenyl aromatic); 0.1 to 10 weight percent of the processing aid selected from linear low density polyethylene, a petroleum resin, and combinations thereof; and less than or equal to 0.5 weight percent of the flame retardant; wherein all weight percents are based on the total weight of the composition.

The present inventors have determined that the use of a processing aid in poly(phenylene ether) compositions results in compositions that can be consistently melt spun into smaller diameter fibers than could be obtained without the processing aid. In some embodiments, the processing aid comprises linear low density polyethylene (LLDPE). LLDPE is prepared by copolymerization of ethylene with an α-olefin comonomer in the presence of a catalyst. In this way, branching is introduced in a controlled manner with uniform chain lengths. In general, the comonomers can be 1-butene, 1-hexene, 1-heptene, 1-octene, and 4-methyl-1-pentene (4M1P). Methods of preparation of LLDPE are known in the art, and include low pressure methods as disclosed, for example, in U.S. Pat. No. 4,076,698. The catalyst can be a Ziegler-Natta catalyst, a metallocene catalyst, or a Phillips catalyst, which comprise titanium, chromium, zirconium, magnesium, and combinations thereof. Catalyst residues can be present in the LLDPE.

The LLDPE can have a density of 0.88 to 0.96 grams per cubic centimeter, specifically 0.90 to 0.94 grams per cubic centimeter, and more specifically 0.92 to 0.93 grams per cubic centimeter. The LLDPE can have a melting point of 100° C. to 136° C., specifically 110° C. to 130° C. The LLDPE can have a melt index of 10 to 40 grams per 10 minutes, specifically 10 to 30 grams per 10 minutes, more specifically 10 to 25 grams per 10 minutes, and still more specifically 17 to 23 grams per 10 minutes, measured in accordance with ASTM D-1238 at 190° C. and 2.16 kilograms. In some embodiments, the composition comprises linear low density polyethylene having a melt volume rate of 10 to 40 grams per 10 minutes, measured in accordance with ASTM D1238-10 at 190° C. and a 2.16 kilogram load.

The composition can comprise 0.1 to 10 weight percent, specifically 0.5 to 5 weight percent, more specifically 1 to 4 weight percent, of LLDPE, based on the total weight of the composition.

In some embodiments, the processing aid comprises a petroleum resin. Petroleum resins are low molecular weight thermoplastic petroleum resins prepared from steam cracked petroleum distillates. These resins, which are produced from mixtures of compounds, are distinguished from higher molecular weight polymers such as polyethylene, polypropylene, polystyrene, and copolymers thereof, which are produced from pure monomers. Petroleum resins are also distinguished from polymers produced from pure monomers by their low molecular weight. The petroleum resin has a number average molecular weight of less than or equal to 5,000, 2,000, or 1,000 atomic mass units and greater than or equal to 200, 400, or 500 atomic mass units; and a weight average molecular weight of 500 to 5,000 atomic mass units, as measured by gel permeation chromatography.

Petroleum resin feedstocks are composed of a variety of reactive and non-reactive aliphatic and aromatic compounds. Petroleum resins can be classified as C5 (aliphatic), C9 (aromatic), C5/C9 (aromatic modified aliphatic), and cycloaliphatic diene-based. Examples of petroleum resins are aliphatic petroleum resins, hydrogenated aliphatic petroleum resins, aliphatic/aromatic petroleum resins, hydrogenated aliphatic/aromatic petroleum resins, cycloaliphatic petroleum resins, hydrogenated cycloaliphatic resins, cycloaliphatic/aromatic petroleum resins, hydrogenated cycloaliphatic/aromatic petroleum resins, hydrogenated aromatic petroleum resins, polyterpene resins, terpene-phenol resins, rosins and rosin esters, hydrogenated rosins and rosin esters, and combinations thereof. As used herein, “hydrogenated”, when referring to the petroleum resin, includes fully, substantially, and partially hydrogenated resins. Examples of aromatic resins include aromatic modified aliphatic resins, aromatic modified cycloaliphatic resins, and hydrogenated aromatic petroleum resins having an aromatic content of 1 to 30 weight percent. Any of the these resins can be grafted with an unsaturated ester or anhydride using methods known in the art. Such grafting can provide enhanced properties to the resin. In some embodiments, the petroleum resin have softening points of 60 to 150° C., specifically 80 to 140° C., more specifically 100 to 140° C., and still more specifically 120 to 130° C. Softening point is measured as a ring and ball softening point according to ASTM E28-99.

The petroleum resin can comprise an aliphatic petroleum derived from C5 monomers. The C5 monomer mixture can comprise a cyclic olefin or diolefin, for example cyclopentene, cyclopentadiene, cyclopentadiene dimer, methyl cyclopentadiene, methyl cyclopentadiene dimer, cyclohexene, cyclohexadiene, or combinations thereof. The petroleum resin can also comprise an aromatic petroleum resin derived from C9 monomers. The C9 monomer mixture can comprise styrene, methylstyrene, a vinyl toluene, indene, a methylindene, or combinations thereof. The petroleum resin can also comprise an aromatic modified aliphatic petroleum resin derived from C5/C9 monomers. These petroleum resins can be partially or fully hydrogenated. Thus, the processing aid can comprise linear low density polyethylene, a partially or fully hydrogenated aliphatic petroleum resin derived from ethylenically unsaturated C5 monomers, ethylenically unsaturated C9 monomers, ethylenically unsaturated C5/C9 monomers, or combinations thereof. In some embodiments, the processing aid comprises a partially or fully hydrogenated aliphatic petroleum resin derived from ethylenically unsaturated C5 monomers, ethylenically unsaturated C9 monomers, ethylenically unsaturated C5/C9 monomers, or combinations thereof.

Hydrogenated aromatic petroleum resins derived from C9 monomers are commercially available from Arakawa Chemical Inc. as ARKON™ P-140, P-125, P-115, P-90, and P-70 (fully hydrogenated), and M-135, M-115, M-100, M-90 (partially hydrogenated). The numeric designations of each refer to the approximate ring and ball softening point of the resin, measured according to ASTM E28-99. In some embodiments, the processing aid comprises a fully hydrogenated aromatic petroleum resin derived from ethylenically unsaturated C9 monomers and having a softening point of 60 to 150° C., measured in accordance with ASTM E28-99, for example ARKON™ P-125, which has a softening point of 125° C.

Examples of other commercially available petroleum resins are EMPR™ 100, 101, 102, 103, 104, 105, 106, 107, 108, 109, 110, 116, 117, and 118 resins, and OPPERA™ resins, available from ExxonMobil Chemical Company; NORSOLENE™ aliphatic aromatic resins available from Cray Valley; EASTOTAC™ resins, PICCOTAC™ resins, and REGALITE™ and REGALREZ™ hydrogenated cycloaliphatic/aromatic resins available from Eastman Chemical Company; WINGTACK™ resins available from Goodyear Chemical Company; coumarone/indene resins available from Neville Chemical Company; QUINTONE™ acid modified C5 resins, C5/C9 resins, and acid-modified C5/C9 resins available from Nippon Zeon; and WINGTACK™ resins available from Goodyear Chemical Company.

The processing aid can also comprise a coumarone-indene resin (coal tar resin), a polyterpene resin, a polyterpene copolymer, a rosin, a rosin ester, or combinations thereof. Examples are SUPER ESTER™ rosin esters available from Arakawa Chemical Company of Japan; SYLVARES™ resins, polyterpene resins, styrenated terpene resins, and terpene phenolic resins available from Arizona Chemical Company; SYLVATAC™ and SYLVALITE™ rosin esters available from Arizona Chemical Company; DERTOPHENE™ terpene phenolic resins and DERCOLYTE™ polyterpene resins available from DRT Chemical Company; PICCOLYTE™ and PERMALYN™ polyterpene resins, rosins, and rosin esters available from Eastman Chemical Company; coumarone/indene resins available from Neville Chemical Company; and CLEARON™ hydrogenated terpene resins available from Yasuhara.

The composition can comprise 0.1 to 10 weight percent, specifically 0.5 to 5 weight percent, and more specifically 1 to 4 weight percent, of the processing aid, based on the total weight of the composition. The present inventors have determined that when the fiber composition comprises 0.1 to 10 weight percent of a processing aid selected from linear low density polyethylene, a petroleum resin, and combinations thereof, the minimum fiber diameter that can be consistently produced is reduced compared to a fiber composition lacking the processing aid. Thus, the fiber composition can provide small diameter fiber. In some embodiments, the fiber diameter is 1 to 50 micrometers, specifically 5 to 40 micrometers, more specifically 10 to 40 micrometers, and still more specifically 15 to 40 micrometers.

In some embodiments, in addition to a processing aid selected from linear low density polyethylene, a petroleum resin, and combinations thereof, the composition comprises an organophosphorus compound comprising a phosphite of formula

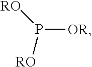

a phosphonate of formula

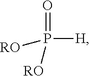

or combinations thereof, wherein each R is independently a C₂₋₁₈ alkyl or C₆₋₁₅ aryl group. Examples of phosphites comprise triethyl phosphite, tri-n-butyl phosphite, tri(2-ethylhexyl) phosphite, trioctyl phosphite, tridecyl phosphite, triisodecyl phosphite, tridodecyl phosphite, trioctadecyl phosphite, triphenyl phosphite, tricresyl phosphite, tri(nonylphenyl) phosphite, didecyl phenyl phosphite, diisodecyl phenyl phosphite, octyl diphenyl phosphite, decyl diphenyl phosphite, isodecyl diphenyl phosphite, or combinations thereof. Examples of phosphonates comprise diethyl phosphonate, di-n-butyl phosphonate, di(2-ethylhexyl) phosphonate, didecyl phosphonate, diisodecyl phosphonate, didodecyl phosphonate, dioctadecyl phosphonate, diphenyl phosphonate, dicresyl phosphonate, di(nonylphenyl) phosphonate, or combinations thereof. Combinations of one or more phosphites and/or phosphonates can be used. In some embodiments, the organophosphorus compound comprises a phosphite of formula

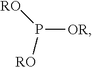

wherein each R is independently a C₂₋₁₈ alkyl. In some embodiments, the organophosphorus compound comprises triisodecyl phosphite. When present, the composition can comprise 0.1 to 10 weight percent, of organophosphorus compound as defined above, based on the total weight of the composition. Within this range, the composition can comprise 0.5 to 5 weight percent, and more specifically 1 to 4 weight percent, of the organophosphorus compound.

The inventors have determined that the melt volume rate of the composition, which is inversely proportional to melt viscosity, is increased by addition of the organophosphorus compound, for example triisodecyl phosphite. The lower viscosity of the compositions comprising the organophosphorus compound leaves a wider processing window, in terms of pump rate, pressure, and temperature, than compositions without the organophosphorus compound. For example, with an increased melt volume rate at a given pump rate and melt temperature, there is less back pressure in the extruder, which feeds the spinneret. This means that, advantageously, the pump rate can be increased, and/or the melt temperature can be decreased. Without wanting to be bound by theory, the inventors believe that the phosphite can decrease melt viscosity by two mechanisms. When the organophosphorus compound is a phosphite, it can reduce the increase in poly(phenylene ether) molecular weight that can occur during melt processing by functioning as an antioxidant. Also, when the organophosphorus compound is a liquid at the processing temperature, it can reduce melt viscosity upon blending with the composition because of its own low viscosity.

Flame retardants are minimized or excluded from the composition. In some embodiments, the excluded flame retardant comprises an organophosphate ester, a phosphine oxide, a phosphorus- and nitrogen-containing organic compound, a polymeric siloxane compound, a boron compound, or combinations thereof. The composition can comprises 0 to 0.5 weight percent of the flame retardant, based on the total weight of the composition. Within this range, the composition can comprise 0 to 0.1 weight percent, specifically 0 to 0.01 weight percent, and more specifically 0 to 0.001 weight percent, of flame retardant. In some embodiments, the composition excludes flame retardants.

In some embodiments, the composition comprises: 50 to 98.9 weight percent of poly(2,6-dimethyl-4-phenylene ether); 1 to 49.9 weight percent of atactic polystyrene; and 0.1 to 10 weight percent of linear low density polyethylene; wherein flame retardant is excluded from the composition; and wherein all weight percents are based on the total weight of the composition.

In some embodiments, the composition comprises: 79.8 to 99.8 weight percent of poly(2,6-dimethyl-1,4-phenylene ether); 0 to 20 weight percent of atactic polystyrene; 0.1 to 5 weight percent of linear low density polyethylene; 0.1 to 5 weight percent of triisodecyl phosphite; and 0 to 0.5 weight percent of a flame retardant comprising an organophosphate ester, a phosphine oxide, a phosphorus- and nitrogen-containing organic compound, a polymeric siloxane compound, a boron compound, or combinations thereof, based on the total weight of the composition; wherein all weight percents are based on the total weight of the composition.

The composition can be formed by mixing 50 to 99.9 weight percent of the poly(phenylene ether); 0 to 49.9 weight percent of the poly(alkenyl aromatic); 0.1 to 10 weight percent of the processing aid; and less than or equal to 0.5 weight percent of a flame retardant, wherein all weight percents are based on the total weight of the composition. All of the above-described variations in the composition apply as well to the method of forming the composition. For example, in some embodiments, poly(2,6-dimethyl-1,4-phenylene ether), atactic homopolystyrene, and LLDPE are mixed to form the composition.

In some embodiments, the fiber composition is formed by melt blending. The melt blending can be performed using known equipment such as Banbury mixers, single-screw extruders, twin-screw extruders, multi-screw extruders, co-kneaders, and the like. For example, the fiber composition can be prepared by extruding the components in a twin-screw extruder at a temperature of 290 to 370° C., specifically 320 to 340° C.

The composition can also be formed by solution blending. In solution blending, the poly(phenylene ether), the processing aid, and optionally the poly(alkenyl) aromatic are dissolved in a solvent to effect mixing. The solvent is then removed by evaporation, for example by vacuum distillation, to provide the composition in powder form. Advantageously, solution blending provides poly(phenylene ether) compositions that have not been subject to the heat history that melt blended poly(phenylene ether) pellets are subject to. When the composition is formed by solution blending rather than melt blending, the content of hydroxyl groups associated with ethylene bridge groups and hydroxyl groups associated with rearranged backbone groups can be reduced compared to compositions prepared by melt blending.

A method of spinning a fiber comprises extruding through a spinneret a composition comprising: 50 to 99.9 weight percent of a poly(phenylene ether); 0 to 49.9 weight percent of a poly(alkenyl aromatic); 0.1 to 10 weight percent of a processing aid selected from linear low density polyethylene, a petroleum resin, and combinations thereof; and less than or equal to 0.5 weight percent of a flame retardant; wherein all weight percents are based on the total weight of the composition. All of the above-described variations in the composition apply as well to the method of spinning the fiber comprising the composition. For example, the method can comprise extruding through a spinneret a composition comprising poly(2,6 dimethyl-1,4-phenylene ether), LLDPE, and atactic homopolystyrene.

Any of several spinning methods can be used to spin the fiber. The spinning method can be, for example, melt spinning, meltblown spinning, spunbound spinning, solution spinning, wet spinning, dry spinning, electrospinning, extrusion spinning, direct spinning, or gel spinning Wet spinning, dry spinning, and electrospinning are all variations of solution spinning. In these methods, the polymer is dissolved in a solvent, and the polymer solution is pumped through a spinneret or die having one or a plurality of small holes. In wet spinning, the spinneret is immersed in an antisolvent bath that causes the fiber to precipitate and solidify when it emerges from the spinneret. In dry spinning, fiber solidification is achieved by evaporation of the solvent, usually by means of a stream of air or inert gas. In electrospinning, the fiber drawing force is supplied by a large electric potential difference between the polymer solution and a target.

In some embodiments, the fiber is formed by melt spinning. In melt spinning, a polymer melt is extruded through a special die called a “spinneret”. The viscous melt exits into cool air and solidifies into fiber. The spinneret can be equipped with a distribution plate, or other design features, which can result in narrowed or lengthened flow channels for the melt as compared to the spinneret without the distribution plate, or which can otherwise cause a high pressure drop through the spinneret. Advantageously, omitting the distribution plate from the spinneret can lower the pressure drop. Moreover, removing the distribution plate can reduce the number of holes per unit area, which can also be advantageous. The number of holes per unit area of the spinneret or distribution plate can affect the ease of melt spinning. The fibers are extruded as a viscous melt until they cool and solidify. The lower the number of holes per unit area, the less likely the individual fibers are to adhere to each other at the spinneret or distribution plate face and bundle together. Thus, the diameter of fibers that can be consistently produced can be reduced when the number of holes per unit area is reduced.

The present inventors have determined that the diameter of fibers that can be consistently produced can be reduced by using a spinneret that does not contain distribution plates or other design features that increase the pressure drop through the spinneret. The inventors have also determined that the diameter of fibers that can be consistently produced can be reduced when the diameter of the holes in the spinneret is increased, which runs counter to intuition. Thus in some embodiments, the holes of the spinneret have a diameter of 0.5 to 2 millimeters, specifically 0.5 to 1.5 millimeters, and more specifically 0.6 to 1 millimeter, and the fiber that can be consistently produced has a smaller diameter than a fiber spun when the holes have a diameter of 0.1 to less than 0.5 millimeter, specifically 0.1 to 0.3 millimeter.

The present inventors have determined that the melt volume rate of the composition also affects the ease of melt spinning. In particular, the diameter of fibers that can be consistently produced can be reduced when the melt volume rate is 1 to 30 cubic centimeters per 10 minutes, specifically 5 to 20 cubic centimeters per 10 minutes, more specifically 10 to 20 cubic centimeters per 10 minutes, according to ASTM D1238 at 300° C. with a 5 kilogram load, compared to compositions having lower melt volume rates.

The fibers can be solid or hollow, and can have various shapes in cross-section, such as for example, round, oval, flat, triangular, tetragonal, polygonal, bilobal, trilobal, or multilobal. Hollow fibers are made by a wet spinning process wherein a polymer solution is injected through an annular nozzle into an antisolvent bath. Hollow fibers can have a wall thickness of about 100 micrometers and a diameter of several millimeters. They are used in gas separation applications. In some embodiments, the fiber is a solid fiber.

In some embodiments, an article comprises a fiber, wherein the fiber comprises a composition comprising: 50 to 99.9 weight percent of a poly(phenylene ether); 0 to 49.9 weight percent of a poly(alkenyl aromatic); 0.1 to 10 weight percent of a processing aid selected from linear low density polyethylene, a petroleum resin; and less than or equal to 0.5 weight percent of a flame retardant; wherein all weight percents are based on the total weight of the composition.

The fibers can be provided in various configurations such as continuous, chopped, carded, loose, spun into yarn, or formed into woven or non-woven textiles. The term “yarn” refers to a bundle of at least two fibers, with at least one of the fibers being the present inventive fiber. Thus, in some embodiments, the article comprises a yarn, or a woven or non-woven textile. All of the above-described variations in the fiber apply as well to articles made from the fiber. For example, in some embodiments, the composition comprising the fiber from which the article is made comprises poly(2,6-dimethyl-1,4-phenylene ether), atactic homopolystyrene, and LLDPE.

In some embodiments, the article comprises a reinforcing textile made from the fiber. The reinforcing textile can be used in fiber-reinforced composites, for example epoxy composites. Reinforcing textiles can have complex structures, for example two- or three-dimensional braided, knitted, woven, or filament wound. In some embodiments, the reinforcing textile comprises other fibers, for example carbon fibers, glass fibers, aromatic polyamide fibers, or combinations thereof. The reinforcing textile can comprise a coating compatible with epoxy resins. In fiber-reinforced composites, the reinforcing textile is impregnated with a curable composition, for example an epoxy resin, and cured or partially cured to form a composite. Thus, in some embodiments, the article comprises a composite made from the reinforcing textile. All of the above-described variations in the fiber apply as well to reinforcing textiles and composites made from the fiber. For example, in some embodiments, the composition comprising the fiber from which the reinforcing textile or composite is made comprises poly(2,6-dimethyl-1,4-phenylene ether), atactic homopolystyrene, and LLDPE.

Pre-impregnated composites, referred to as “pre-pregs”, are composites in which the curable composition is partially cured. Partial curing is curing sufficient to reduce or eliminate the wetness and tackiness of a curable composition but not sufficient to fully cure the composition. A plurality of pre-pregs can be laminated and fully cured to form an electronic laminate, for example a printed circuit board. Thus, in some embodiments, the article comprises a printed circuit board made from the composite. All of the above-described variations in the fiber apply as well to printed circuit boards made from the fiber. For example, in some embodiments, the composition comprising the fiber from which the printed circuit board is made comprises poly(2,6-dimethyl-1,4-phenylene ether), atactic homopolystyrene, and LLDPE.

The invention includes at least the following embodiments.

### Embodiment 1

A fiber comprising a composition comprising: 50 to 99.9 weight percent of a poly(phenylene ether); 0.1 to 10 weight percent of a processing aid comprising linear low density polyethylene, a petroleum resin, or combinations thereof; and 0 to 0.5 weight percent of a flame retardant; wherein all weight percents are based on the total weight of the composition.

### Embodiment 2

The fiber of embodiment 1, wherein the composition comprises 90 to 99.9 weight percent of the poly(phenylene ether); and wherein poly(alkenyl aromatic) is excluded from the composition.

### Embodiment 3

The fiber of embodiment 1, wherein the composition comprises 50 to 98.9 weight percent of the poly(phenylene ether); and further comprises 1 to 49.9 weight percent of a poly(alkenyl aromatic).

### Embodiment 4

The fiber of any of embodiments 1-3, wherein the processing aid comprises linear low density polyethylene, a partially or fully hydrogenated aliphatic petroleum resin derived from ethylenically unsaturated C5 monomers, ethylenically unsaturated C9 monomers, ethylenically unsaturated C5/C9 monomers, or combinations thereof.

### Embodiment 5

The fiber of any of embodiments 1-3, wherein the processing aid comprises linear low density polyethylene having a melt volume rate of 10 to 40 grams per 10 minutes, measured in accordance with ASTM D1238-10 at 190° C. and a 2.16 kilogram load.

### Embodiment 6

The fiber of any of the embodiments 1-3, wherein the processing aid comprises a partially or fully hydrogenated aliphatic petroleum resin derived from ethylenically unsaturated C5 monomers, C9 monomers, ethylenically unsaturated C5/C9 monomers, or combinations thereof.

### Embodiment 7

The fiber of any of embodiments 1-3, wherein the processing aid comprises a fully hydrogenated aromatic petroleum resin derived from ethylenically unsaturated C9 monomers and having a softening point of 60 to 150° C., measured in accordance with ASTM E28-99.

### Embodiment 8

The fiber of any of embodiments 1-7, further comprising 0.1 to 10 weight percent, based on the total weight of the composition, of an organophosphorus compound comprising a phosphite of formula

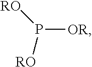

a phosphonate of formula

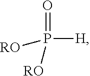

or combinations thereof, wherein each R is independently a C₂₋₁₈ alkyl or C₆₋₁₅ aryl group.

### Embodiment 9

The fiber of embodiment 8, wherein the organophosphorus compound comprises a phosphite of formula

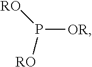

wherein each R is independently a C₂₋₁₈ alkyl.

### Embodiment 10

The fiber of any of embodiments 1-9, wherein the poly(phenylene ether) has an intrinsic viscosity of 0.25 to 0.5 deciliters per gram, measured at 25° C. in chloroform.

### Embodiment 11

The fiber of any of claims 1 and 3-10, wherein the poly(phenylene ether) comprises poly(2,6-dimethyl-4-phenylene ether); the poly(alkenyl aromatic) comprises atactic polystyrene; the processing aid comprises linear low density polyethylene; and flame retardant is excluded from the composition.

### Embodiment 12

The fiber of embodiment 1, wherein the composition comprises: 79.8 to 99.8 weight percent of poly(2,6-dimethyl-1,4-phenylene ether); 0 to 20 weight percent of atactic polystyrene; 0.1 to 5 weight percent of linear low density polyethylene; 0.1 to 5 weight percent of triisodecyl phosphite; and 0 to 0.5 weight percent of a flame retardant comprising an organophosphate ester, a phosphine oxide, a phosphorus- and nitrogen-containing organic compound, a polymeric siloxane compound, a boron compound, or combinations thereof, based on the total weight of the composition; wherein all weight percents are based on the total weight of the composition.

### Embodiment 12a

A fiber comprising a composition comprising: 79.8 to 99.8 weight percent of poly(2,6-dimethyl-1,4-phenylene ether); 0 to 20 weight percent of atactic polystyrene; 0.1 to 5 weight percent of linear low density polyethylene; 0.1 to 5 weight percent of triisodecyl phosphite; and 0 to 0.5 weight percent of a flame retardant comprising an organophosphate ester, a phosphine oxide, a phosphorus- and nitrogen-containing organic compound, a polymeric siloxane compound, a boron compound, or combinations thereof, based on the total weight of the composition; wherein all weight percents are based on the total weight of the composition.

### Embodiment 13

The fiber of any of embodiments 1-12, wherein the fiber is made by melt spinning, and the fiber diameter is 1 to 50 micrometers.

### Embodiment 14

An article comprising a fiber, wherein the fiber comprises a composition comprising: 50 to 99.9 weight percent of a poly(phenylene ether); 0.1 to 10 weight percent of a processing aid selected from linear low density polyethylene, a petroleum resin, and combinations thereof; and 0 to 0.5 weight percent of a flame retardant; wherein all weight percents are based on the total weight of the composition.

### Embodiment 15

The article of embodiment 14, comprising a yarn, or a woven or non-woven textile.

### Embodiment 16

The article of embodiment 14, comprising a reinforcing textile made from the fiber.

### Embodiment 17

The article of embodiment 16, wherein the reinforcing textile further comprises carbon fibers, glass fibers, aromatic polyamide fibers, metal fibers, or combinations thereof.

### Embodiment 18

The article of embodiment 16, comprising a composite made from the reinforcing textile.

### Embodiment 19

The article of embodiment 18, comprising a printed circuit board made from the composite.

### Embodiment 20

A method of forming a fiber, comprising extruding through a spinneret a composition comprising: 50 to 99.9 weight percent of a poly(phenylene ether); 0.1 to 10 weight percent of a processing aid selected from linear low density polyethylene, a petroleum resin, and combinations thereof; and 0 to 0.5 weight percent of a flame retardant; wherein all weight percents are based on the total weight of the composition.

### Embodiment 21

The method of embodiment 20, wherein the spinning is melt spinning.

### Embodiment 22

The method of embodiment 21, wherein the holes of the spinneret have a diameter of 0.5 to 2 millimeters, and the fiber has a smaller diameter than a fiber spun when the holes have a diameter of 0.1 to less than 0.5 millimeters.

The invention is further illustrated by the following non-limiting examples.

### EXAMPLES

These examples illustrate the unexpected benefits of adding LLDPE and triisodecyl phosphite to poly(2,6-dimethyl-1,4-phenylene ether)/polystyrene blends that are melt spun fibers.

Components used to prepare the compositions are described in Table 1.

TABLE 1

| Component | Description |
|---|---|
| PPE 0.46 | Poly(2,6-dimethyl-1,4-phenylene ether), CAS Reg. No. |
| | 25134-01-4, having an intrinsic viscosity of 0.46 |
| | deciliter per gram, measured in chloroform at 25° C., |
| | and a M_{w} of 47,400 g/mol, an Mₙ of 7,500 g/mol, and a |
| | polydispersity of 6.3, measured by GPC; and obtained |
| | as PPO ™ 646 from SABIC Innovative Plastics. |
| PPE 0.40 | Poly(2,6-dimethyl-1,4-phenylene ether), CAS Reg. No. |
| | 25134-01-4, having an intrinsic viscosity of 0.40 |
| | deciliter per gram, measured in chloroform at 25° C., |
| | and a M_{w} of 38,700 g/mol, an Mₙ of 7,400 g/mol, and a |
| | polydispersity of 5.3, measured by GPC; and obtained |
| | as PPO ™ 640 from SABIC Innovative Plastics. |
| PPE 0.33 | Poly(2,6-dimethyl-1,4-phenylene ether), CAS Reg. No. |
| | 25134-01-4, having an intrinsic viscosity of 0.33 |
| | deciliter per gram measured in chloroform at 25° C., |
| | and a M_{w} of 31,100 g/mol, an Mₙ of 7,400 g/mol, and a |
| | polydispersity of 4.2, measured by GPC; and obtained |
| | as PPO ™ 630 from SABIC Innovative Plastics. |
| PS | Atactic polystyrene in pellet form, CAS Reg. No. |
| | 9003-53-6, having a melt flow index of 4.8 grams per |
| | 10 minutes, measured at 200° C. and a 5 kilogram load |
| | according to ASTM D1238, and a mineral oil content of |
| | less than 2 weight percent; and obtained as EA3130 |
| | from Americas Styrenics. |
| LLDPE | Linear low density polyethylene, CAS Reg. No. |
| | 25087-34-7, having a density of 0.9200 grams per |
| | cubic centimeter and a MVR of 20 cubic centimeters |
| | per 10 minutes at 190° C./2.16 kilograms, and obtained |
| | as CERTENE ™ LLI-2024G from ExxonMobil. |
| TDP | Triisodecyl phosphite, CAS Reg. No. 25448-25-3, |
| | obtained as DOVERPHOS ™ 6 from Dover Chemical. |

### Example 1 and Comparative Example 1

The components of Example 1 and Comparative Example 1 (Table 2) were compounded on a 25-millimeter twin screw extruder. The compositions are summarized in Table 2.

TABLE 2

| | |
|---|---|
| Comp. Ex. 1 | Ex. 1 |

COMPONENT (PARTS BY WEIGHT)

| | | |
|---|---|---|
| PPE 0.46 | 70 | 70 |
| PS | 30 | 30 |
| LLDPE | 0 | 2.4 |

These compositions were melt spun on a Hills Pilot Fiber Spinning line equipped with a 144-hole spinneret operating at 320° C. The smallest diameter fiber that could be produced without frequent fiber breakage was about 32 micrometers for Comparative Example 1 and 28 micrometers for Example 1. Upon starting melt spinning, the fibers of Comparative Example 1 appeared to be more brittle and were more easily entangled in the spinning drums than the fibers of Example 1. During melt spinning, the fibers of Comparative Example 1 were very difficult to handle. It was difficult to collect the fibers onto bobbins to quantify the denier. In contrast, the fibers of Example 1 were easier to string up, and it was possible to collect the fiber onto bobbins readily and reproducibly.

Surprisingly, scanning electronic microscope analysis of the fibers indicated that nearly all of the LLDPE in the composition of Example 1 formed a continuous surface layer about 200 nanometers thick. The FIGURE is a scanning electron microscope image of a portion of the cross section of a fiber comprising the composition of Example 1. Feature 1 is the fiber core, feature 2 is the outer surface of the fiber, and the LLDPE surface layer is discernible between the arrows of 3. While not wishing to be bound by theory, it is believed that this surface layer of LLDPE is responsible for the improved spinning performance of Example 1.

### Examples 2-6

The components of Examples 2-6 were compounded on a 25-millimeter twin screw extruder. The resulting compositions contained approximately 90 weight percent poly(2,6-dimethyl-4-phenylene ether) having different molecular weights, and various amounts of processing aids were evaluated. The compositions are summarized in Table 3.

TABLE 3

| | | | | |
|---|---|---|---|---|
| Ex. 2 | Ex. 3 | Ex. 4 | Ex. 5 | Ex. 6 |

COMPONENT (PARTS BY WEIGHT)

| | | | | | |
|---|---|---|---|---|---|
| PPE 0.46 | 90 | 0 | 0 | 0 | 0 |
| PPE 0.40 | 0 | 90 | 89 | 0 | 0 |
| PPE 0.33 | 0 | 0 | 0 | 90 | 89 |
| PS | 10 | 6.6 | 6.6 | 6.6 | 6.6 |
| LLDPE | 2.4 | 2.4 | 2.4 | 2.4 | 2.4 |
| TDP | 0 | 1 | 2 | 1 | 2 |

MELT VOLUME RATES

| | | | | | |
|---|---|---|---|---|---|
| MVR, cm³/10 min. | <1 | 5.7 | 9.3 | 10 | 16.9 |

The melt volume flow rates of these compositions were measured using a Goettfert Melt Indexer according to ASTM D1238 at 300° C. with a 5 kilogram load. These compositions were melt spun on a Hills Pilot Fiber Spinning line equipped with a 72-hole spinneret using 1.0-millimeter diameter holes. The results are summarized in Table 3. Example 2, having the lowest MVR, and therefore the highest melt viscosity, was found to be the most difficult to process, and no fibers could be collected due to constant fiber breakage. The easiest composition to melt spin was Example 6, which had the highest MVR (lowest viscosity). Melt spinning conditions are summarized in Table 4. With the lowest pressure of all the compositions, due to its high MVR, Example 6 had the largest melt spinning window in terms of flow rate, pressure, and temperature. The minimum achievable fiber diameter without frequent breakage for Example 6 was 31 micrometers. These results show that increasing the melt viscosity of the composition by reducing the poly(2,6-dimethyl-4-phenylene ether) molecular weight, for example by the use of PPE 0.33 (Example 6), in place of PPE 0.46 (Example 2) or PPE 0.40 (Examples 3 and 4), and by adding triisodecyl phosphite, improves the spinnability of the composition and enables the production of low diameter fibers having a high poly(2,6-dimethyl-4-phenylene ether) content (approximately 90 weight percent).

TABLE 4

| | Pump Rate | Pressure | Temperature | Hole Diameter |
|---|---|---|---|---|
| Composition | (rpm) | (psi) | (° C.) | (mm) |
| Ex. 6 | 12 | 750 | 315 | 0.6 |
| Ex. 6 | 20 | 860 | 318 | 1.0 |
| Ex. 5 | 12 | 1100 | 315 | 0.6 |
| Ex. 6 | 12 | 1200 | 300 | 1.0 |
| Ex. 3 | 20 | 1300 | 318 | 1.0 |
| Ex. 6 | 12 | 1800 | 300 | 0.6 |
| Ex. 5 | 12 | 1800 | 300 | 1.0 |
| Ex. 3 | 16 | 1900 | 310 | 1.0 |
| Ex. 5 | 16 | 2100 | 310 | 1.0 |

### Example 7

A composition consisting of 50 parts PPE 0.46, 50 parts polystyrene, and 2.4 parts LLDPE, was melt spun on a Hills Pilot Fiber Spinning line using a melt temperature of 320° C. When a rectangular spin pack with 144 holes of 0.6-millimeter diameter was used, the minimum achievable fiber diameter without constant fiber breakage was 35 micrometers.

Distribution plates were used to distribute the melt over all 144 holes of the spinneret. However, very narrow flow channels were present in the distribution plates. Removal of these plates created much larger flow channels, and limited the total number of holes to 72, which decreased the number of holes per unit area. When melt spinning of Example 7 was conducted with the distribution plates of the spinneret removed, the fibers were easier to spin, and the minimum achievable fiber diameter was reduced to 20 micrometers.

### Example 8

The composition of Example 1 was melt spun on a Hills Pilot Fiber Spinning line. Contrary to expectations, a spinneret with 1.0- or 0.6-millimeter diameter holes produced smaller diameter fibers than a spinneret with 0.4- or 0.2-millimeter diameter holes. Various attempts were made to melt spin fibers with 0.4- and 0.2-millimeter diameter holes, which had length to diameter ratios from 2 to 4, at temperatures from 300 to 315° C., but with no success. In all trials, the pressure in the pack was at or near the maximum possible, and it was still not possible to collect fiber onto bobbins. In contrast, fibers were collected on bobbins with both 0.6- and 1.0-millimeter spinnerets.

All ranges disclosed herein are inclusive of the endpoints, and the endpoints are independently combinable with each other. Each range disclosed herein constitutes a disclosure of any point or sub-range lying within the disclosed range.

The use of the terms “a”, “an”, “the”, and similar articles in the context of describing the invention (especially in the context of the following claims) is to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

As used herein, “minimized” means that the composition comprises 0 to 0.5 weight percent, specifically 0 to 0.1 weight percent, more specifically 0 to 0.01 weight percent, and still more specifically 0 to 0.001 percent, based on the total weight of the composition, of the minimized or excluded component. As used herein, the term, “excluded” means that the component is not added to, and is therefore absent from, the composition.

As used herein, the term, “excluded” means that the excluded component is not added to, and is therefore absent from, the composition.

1. A method of forming a fiber, comprising extruding through a spinneret a composition comprising:
50 to 99.9 weight percent of a poly(phenylene ether);
0.1 to 10 weight percent of a processing aid selected from linear low density polyethylene, a petroleum resin, and combinations thereof; and
0 to 0.5 weight percent of a flame retardant;
wherein all weight percents are based on the total weight of the composition.

2. The method of claim 1, wherein the spinning is melt spinning.

3. The method of claim 2, wherein the holes of the spinneret have a diameter of 0.5 to 2 millimeters, and the fiber has a smaller diameter than a fiber spun when the holes have a diameter of 0.1 to less than 0.5 millimeters.

4. The method of claim 1, wherein the composition comprises 90 to 99.9 weight percent of the poly(phenylene ether); and wherein poly(alkenyl aromatic) is excluded from the composition.

5. The method of claim 1, wherein the composition comprises 50 to 98.9 weight percent of the poly(phenylene ether); and further comprises 1 to 49.9 weight percent of a poly(alkenyl aromatic).

6. The method of claim 1, wherein the processing aid comprises linear low density polyethylene, a partially or fully hydrogenated aliphatic petroleum resin derived from ethylenically unsaturated C5 monomers, ethylenically unsaturated C9 monomers, ethylenically unsaturated C5/C9 monomers, or combinations thereof.

7. The method of claim 1, wherein the processing aid comprises linear low density polyethylene having a melt volume rate of 10 to 40 grams per 10 minutes, measured in accordance with ASTM D1238-10 at 190° C. and a 2.16 kilogram load.

8. The method of claim 1, wherein the processing aid comprises a partially or fully hydrogenated aliphatic petroleum resin derived from ethylenically unsaturated C5 monomers, C9 monomers, ethylenically unsaturated C5/C9 monomers, or combinations thereof.

9. The method of claim 1, wherein the processing aid comprises a fully hydrogenated aromatic petroleum resin derived from ethylenically unsaturated C9 monomers and having a softening point of 60 to 150° C., measured in accordance with ASTM E28-99.

10. The method of claim 1, wherein the composition further comprises 0.1 to 10 weight percent, based on the total weight of the composition, of an organophosphorus compound comprising a phosphite of formula 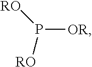
a phosphonate of formula 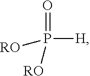
or combinations thereof, wherein each R is independently a C₂₋₁₈ alkyl or C₆₋₁₅ aryl group.

11. The method of claim 10, wherein the organophosphorus compound comprises a phosphite of formula 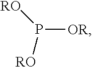
wherein each R is independently a C₂₋₁₈ alkyl.

12. The method of claim 1, wherein the poly(phenylene ether) has an intrinsic viscosity of 0.25 to 0.5 deciliters per gram, measured at 25° C. in chloroform.

13. The method of claim 5, wherein the poly(phenylene ether) comprises poly(2,6-dimethyl-4-phenylene ether), the polyalkenyl aromatic comprises atactic polystyrene; the processing aid comprises linear low density polyethylene; and flame retardant is excluded from the composition.

14. The method of claim 1, wherein the fiber comprises a composition comprising
79.8 to 99.8 weight percent of poly(2,6-dimethyl-1,4-phenylene ether);
0 to 20 weight percent of atactic polystyrene;
0.1 to 5 weight percent of linear low density polyethylene;
0.1 to 5 weight percent of triisodecyl phosphite; and
0 to 0.5 weight percent of a flame retardant comprising an organophosphate ester, a phosphine oxide, a phosphorus- and nitrogen-containing organic compound, a polymeric siloxane compound, a boron compound, or combinations thereof, based on the total weight of the composition;
wherein all weight percents are based on the total weight of the composition.

15. The method of claim 1, wherein the fiber has a diameter of 1 to 50 micrometers.
